(19) United States
(12) Patent Application Publication
(10) Pub. No.: US 2017/0297130 A1
(43) Pub. Date: Oct. 19, 2017

(54) METHOD FOR SHORTENING THE PROCESS TIME DURING THE SOLDERING OF ELECTRIC OR ELECTRONIC COMPONENTS BY MEANS OF ELECTROMAGNETIC INDUCTION HEATING

(71) Applicant: FEW Fahrzeugelektrikwerk GmbH & Co. KG, Zwenkau (DE)

(72) Inventor: André Jenrich, Leipzig (DE)

(21) Appl. No.: 15/509,534

(22) PCT Filed: Sep. 10, 2015
(86) PCT No.: PCT/EP2015/070730

§ 371 Date: Mar. 8, 2017

(30) Foreign Application Priority Data
Sep. 12, 2014 (DE) 10 2014 013 553.5
Mar. 11, 2015 (DE) 10 2015 003 086.8

(51) Int. Cl. B23K 1/002; B23K 35/26; B23K 1/00; H01R 4/02; B23K 1/19; B23K 103/04; B23K 103/00

(52) U.S. Cl. CPC B23K 1/002; H01R 4/02; B23K 35/262; B23K 1/0016; B23K 1/19; B23K 35/264; B23K 2203/05; B23K 2203/54; B23K 2203/04

(57) ABSTRACT

A method for reducing a process time for soldering electrical or electronic components by electromagnetic induction heating, in particular soldering electrical contact elements with solder connection surfaces which are applied to a non-metallic substrate, in particular a glass pane, the method comprising the steps providing an electrical contact element configured as a solder base and made from an iron nickel or iron chromium alloy material; applying a lead free connection material to the soldering base, wherein the connection material or the solder is made from a lead free material, in particular Bi₅₇Sn₄₂Ag₁, Bi₅₇Sn₄₀Ag₃, SAg_{3.8}Cu_{0.7} or Sn₅₅Bi₄₄Ag₁; positioning the soldering base on the respective solder contact surface; inductive heating of the solder base by high frequency energy with increased heating of the solder base material and reduced heating of the material of the respective solder connection surface; and completing the soldering step after a time period of less than or equal to 10 seconds, advantageously 4 to 6 seconds. The invention also relates to a contact element configured as a particular soldering base.

The invention relates to method for process time reduction for soldering electrical or electronic components through electro-magnetic induction heating in particular soldering electrical contact elements with solder contact surfaces which are applied to a non-metallic substrate in particular a glass pane and contact elements for the method.

DE 10 2004 057 630 B3 relates to a method for soldering a plurality of electrical connections where contact elements are soldered with solder contact surfaces arranged on a non-metallic pane.

The known method uses an inductive soldering process. The method uses a soldering tool that includes an electrically fed loop or coil which emits a magnetic field with a predetermined frequency to the soldering locations in a portion covering plural solder connection surfaces in order to heat the soldering locations by induction, wherein a size and the shape of the soldering tool is sized with respect to its loop or coil as a function of a surface where plural soldering locations are arranged that are to be heated simultaneously in a soldering process.

The frequency of an alternating voltage applied to the loop or coil is adapted to the connection geometry and is adjusted to 150 kHz. In particular the frequency of the magnetic field is between 5 and 150 kHz.

The teachings according to DE 10 2004 057 630 B3 are based on the finding that experiments of inductive soldering with frequency in a range between 700 and 900 kHz have not yielded any satisfactory results. It has been found that the conductor structures on the pane surface that are used as solder connection surfaces and which are made from a fired thick layer made from a silk screening paste with a relatively high silver content heat up excessively and reject a large amount of heat whereas the components to be soldered are not sufficiently heated.

As a cause it is stated in that the conductor structure or its material has a high level of absorption of the inductively introduced high frequency waves. The heating does not penetrate into a depth of a body at all or only very slowly when high frequencies are being used but the heating remains at a surface of the body which is designated as so called skin effect.

Accordingly contrary to the findings of the equipment manufacturers the frequency of the inductive waves is significantly reduced during inductive soldering, thus in a range below 150 kHz. This frequency is intended to increase a penetration depth of the magnetic field. As a disadvantage it is pointed out in DE 10 2004 057 630 B3 that an increased electrical power has to be provided since the rather low frequency radiation is subjected to rather high transmission loses in the air gap and in the body of the pane. Therefore a higher field strength of the low frequency magnetic field has to be used.

DE 202 03 202 U1 discloses an electrical connection, in particular a crimp connection for at least one electrical device to be arranged at a pane of a vehicle, in particular a motor vehicle, like e.g. an antenna. The electrical connection includes at least one soldering pad that is essentially flat and to be soldered onto the pane and at least one crimping component that is connected with the soldering pad through welding or soldering and which crimps at least one electrical cable.

According to this solution the connection between the soldering pad and the crimp component is configured as at least one connection component wherein the connection component is configured so that the crimping component is bendable backward into the portion of the soldering pad and/or beyond the portion of the soldering pad.

DE 10 2006 047 764 A1 discloses a lead free soft solder with improved properties at temperatures greater than 150° C. The lead free soft solder is based on a Sn-In-Ag solder alloy including 88% to 98.5% by weight Sn, 1% to 10% by weight In, 0.5% to 3.5% by weight Ag, 0% to 1% by weight Cu and a doting with a crystallization modifier in particular at the most 100 ppm neodymium. Allegedly this solder has good compatibility with connection materials that are being used and a high fatigue strength.

DE 20 2011 100 906 U1 discloses an electrical connection element for contacting a conductive structure arranged on a flat carrier using a thermally bonding connection material wherein devices for fixating a conductor are arranged on a side of the connection element that is oriented away from the conductive structure. The connection element is configured as a soldering base which has at least approximately a figure eight or circular ring shape. Advantageously the known soldering base is made from plural engaging circular rings or circular ring segments. However, it has become apparent that a high concentration of the electromagnetic field is generated in a connection element of this type in a portion of the engaging circular rings or circular ring segments during an inductive soldering process which leads to overheating the glass structure during soldering on a respective collecting rail of the glass pane and thus leads to a destruction of the glass pane.

Thus, it is an object of the invention to provide an improved method for shortening process time when soldering electrical or electronic components by electromagnetic induction heating, in particular soldering electrical contact elements with solder connection surfaces which are applied to a non-metal substrate, in particular a glass pane, wherein the method facilitates an optimum heating of the object to the soldered in an inductive manner with well-known frequencies without opposite contact surfaces being subjected to excessive heating with the associated detrimental effects of the non-metal substrates employed, in particular when the substrate is a glass pane, e.g. a vehicle window pane.

Furthermore it is an object of the invention to provide an improved contact element for soldering by electromagnetic induction heating wherein the contact element avoids local overheating during a soldering process and thus facilitates even heating of the soldering partners.

The object of the invention is achieved by the teachings defined in patent claim 1 or 9, wherein the dependent claims disclose at least advantageous embodiments and improvements.

The invention is based on the basic finding of the principle of induction heating for soldering. The possibility of partial heating during induction soldering facilitates implementing solder joints at work pieces which may only be heated for a short time period and only at the solder joint. Thus, inductive soldering has the basic advantage that undesirable influences upon the structure and the strength of adjacent zones are avoided.

The basic principle of induction heating uses the finding that electrical conductors which are flowed through by an alternating current generate an electromagnetic field about themselves which oscillates about a zero point with a phase shift analogous to the frequency of the alternating current. When an electrically conductive body is moved close to the conductor that is flowed by electrical current then a voltage is induced in the electrically conductive body which also causes an alternating current, the so called secondary electrical current. This induced alternating current is phase shifted by 180° relative to the primary current. When there is sufficient current the second conductor or the work piece in the instant case the soldering base is heated by the heat generated by the electrical current. The thermal energy can be determined using Newton's laws for non-ferro magnetic materials.

The primary conductor that is flowed by the electrical current is designated as inductor. The shape of the inductor is adapted to a shape of the work piece section to be heated, in particular the soldering base:

There is an option to use inducing one winding inductors and also multi-winding inductor coils with n windings, wherein in the latter case the secondary current in the work piece increases proportional to the number of windings and reaches n times the value of the primary current.

The induced currents mostly only flow at the surface of the conductor. The thermal energy that is generated in an inductively heated metal body is thus accumulated in its surface layer whose thickness is a function of the frequency and of the electric and magnetic properties of the material. The skin effect is caused in that an alternating current flowing in a conductor causes eddy currents in its interior through self-induction, wherein the eddy currents are oriented opposite to the primary current. This super position causes higher resistance in an interior of the conductor which causes a concentration of the electrical current at the surface of the conductor. This effect increases with increasing frequency so that merely a very high surface layer of the conductor is flowed through at high frequencies. This furthermore has the effect that the effective resistance increases substantially with increasing frequency compared to a direct current resistance. Furthermore current density decreases with an exponential function from the surface to the interior of the conductor. Thus, with reference to inductive heating it is found that a work piece introduced into an inductor also acts like a conductor that is flowed through by an electrical current.

Independently from problems caused by skin effect an important advantage of induction heating compared to other thermal heating methods is based on the fact that the heat is generated directly in the work piece itself. Thus, the heat does not have to be transmitted by convection, radiation and/or heat conduction which facilitates very quick heating as a matter of principle.

When a ferro-magnetic material is used for the material to be soldered the thermal energy is being added which is generated by demagnetization due to the continuously changing electromagnetic field.

The invention overcomes the prejudice persisting with persons skilled in the art which is based on the perception that no high frequencies shall be used when soldering metal soldering bases on electrical contact elements with soldering contact surfaces in order to prevent excessive heating of the soldering contact surfaces since otherwise excessive heat is rejected and causes insufficient heating of the components to be soldered.

It was found by the inventors that forming electrical contact elements, in particular soldering bases from a material made from an iron nickel or iron chromium alloy provides a very quick heating of the ferro-magnetic elements through higher eddy current losses also at high frequencies. Since the solder connection surfaces which are typically made from a thick layer material that includes silver form a much better electrical conductor the amount of energy transposed therein through induction is much lower so that the desired very short process duration causes quick and sufficient heating of the material of the soldering base but only a small amount of heating of the respective solder contact surface. Thus, only a small amount of energy is conducted onto the substrate, in particular the glass pane that is being used, so that thermal stresses caused by the soldering process can be avoided.

It is another advantage that the method according to the invention uses a lead free connection material, in particular a lead free solder for the soldering process.

When performing lead free soldering the ductile properties of the omitted lead are replaced by adapting a thermal expansion coefficient of the glass pane and the soldering material in that copper in the soldering base material is replaced thus in particular by an iron nickel or an iron chromium alloy. In particular an alloy material of this type leads to a particularly advantageous effect of higher eddy current loses with quicker and more intense heating so that multiple advantages are achieved with respect to the recited aspect of thermal expansion coefficients and the desired process time reduction during soldering.

Surprisingly the silver layer material of the solder connection surfaces arranged on the pane is not affected negatively or damaged during the proposed process and while using high frequency energy in a range of about 900 kHz.

Further improving the method according to the invention the process can be configured so that a short cooling phase is performed after a short first inductive heating step and followed by an additional inductive heating step. A cycle of this type can also be performed several times, thus within the very short overall process time. Running the process like that increases shear strength of the achieved soldering connection significantly.

The electrical contact element according to the invention is used for contacting a conductive structure arranged on a flat carrier, in particular the recited glass pane wherein the electrically conductive structure is in turn made from a thick silver layer.

As stated supra the carrier or the substrate is advantageously configured as a pane made from a safety glass in particular suited for use in motor vehicles. The conductive structure is an electrically conductive arrangement, e.g. configured as an antenna or heating conductor arrangement which can be implemented by silk screening. As a connecting device lead free solder is used in particular which is arranged on a side of the electrical connection element which is free from a strand end sleeve or a similar device for attaching a flexible conductor.

The contact element configured as a soldering base includes at least an approximated figure eight or an approximated circular ring shape. Thus, the soldering base is configured flat and made from an iron nickel or iron chromium alloy.

According to the invention the soldering base is made from plural circular surfaces, circular rings or circular ring segments that are not engaging each other or contacting each other, thus they are offset from each other. Between the circular surfaces there is a connection surface element which is used for fixating a connecting device, e.g. a strand end sleeve.

The connection material can be advantageously applied to the contact element as a soldering tin bead on one side of the contact element.

Advantageously the contact element, this means the soldering base is made from FeCr₂₈ or FeNi₂₉Co₁₇.

The lead free solder includes at least the following alloy components: Bi₅₇Sn₄₂Ag₁, Bi₅₇Sn₄₀Ag₃, SnAg_{3.8}Cu_{0.7} or Sn₅₅Bi₄₄Ag₁.

Selecting the material of the electric contact element yields an expansion coefficient which is very close to an expansion coefficient of automotive glass panes, namely 9×10⁻⁶ K. Possibly generated or remaining tensions are distributed in the glass by the particular shape of the soldering base and received by the glass material without bearing the risk of impairment or destruction.

For example the soldering base is configured as an “eight” that is quasi pulled apart in the longitudinal direction and has a length of approximately 20 mm and respectively an exterior end diameter of approximately 6 mm with a material thickness of approximately 0.8 mm. It is within the scope and spirit of the invention to modify the shape recited supra of the soldering base into a pulled apart double eight without departing from the teachings of the invention. The connection surface element has a length of approximately 9 mm.

Surprisingly it has become evident that in particular the proposed surface shape of the contact element suffices for an optimum inductive heating in the sense of the desired quick heating and reduction of the process time, wherein at least one of the surface sides of the soldering base has a circumferential radius of e.g. 0.2 mm in order to avoid detrimental electromagnetic scatter fields.

In exemplary experiments for soldering contact elements or soldering bases including iron and nickel or stainless steel a process time reduction of greater than 50% compared to inductive soldering of materials including copper was demonstrated. Comparing the proposed inductive soldering with classic resistance soldering of the electrical contact elements the process time of 12 to 15 second is reduced down to 4 to 6 seconds for inductive soldering.

The method according to the invention is characterized by the steps providing an electrical contact element configured as a soldering base, wherein the contact element material is based on an iron nickel or iron chromium alloy. Furthermore a lead free connection material is applied to the contact element, this means the soldering base. Thereafter the soldering base is positioned on the respective solder contact surface which is advantageously made from a silver thick layer material that is arranged on a glass pane.

Thereafter inductive heating of the soldering base is performed by high frequency energy with resulting increased heating of the soldering base material and only reduced heating of the solder including material of the respective solder connection surface. The soldering step is completed after a very short time period, in particular less than or equal to 10 seconds, in particular a time period of 4 to 6 seconds.

The electrical contact element according to the invention, this means the especially configured soldering base shall now be described in more detail based on an embodiment with reference to drawing figures, wherein:

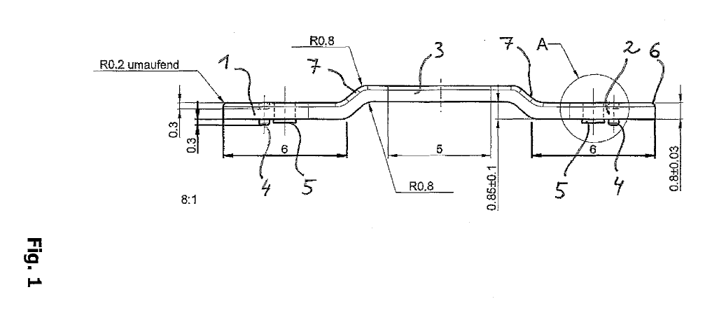

FIG. 1 illustrates a side view of the soldering base with exemplary dimensions at 8:1 scale;

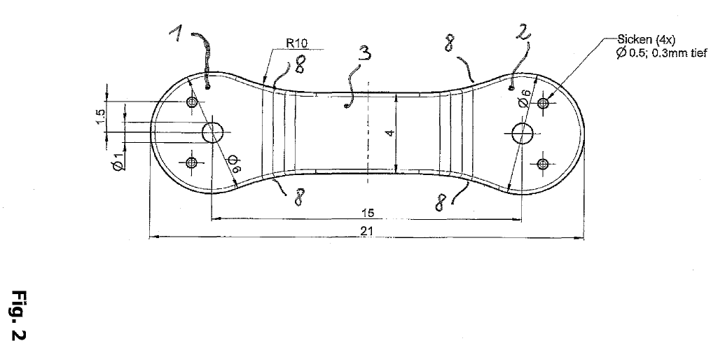

FIG. 2 illustrates a top view of the contact element according to FIG. 1;

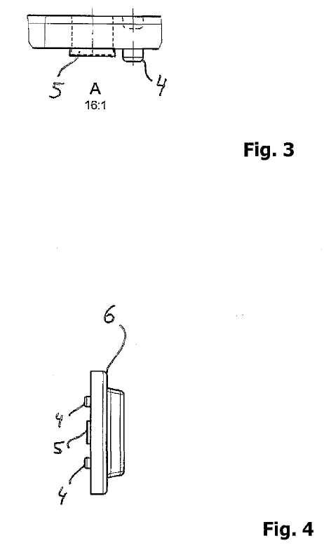

FIG. 3 illustrates a detail view of FIG. 1; and

FIG. 4 illustrates a narrow side view of the soldering base. The electrical connection element illustrated in the figures is configured as a soldering base and made from two circular surface segments 1; 2.

Between the circular segments 1; 2 there is a connection surface element 3. Accordingly in top view according to FIG. 2 the soldering base is shaped like an elongated “eight” with two non-engaging circular surface segments 1; 2 and the connection surface portion 3.

Advantageously a conductor or a strand end sleeve (not illustrated) is attached in the portion of the connection surface portion 3 e.g. by welding or soldering.

In the portion of the circular surface segments 1; 2 protrusions 4 are formed at a bottom side of the soldering base wherein the protrusions are beads that are pressed through.

The protrusions 4 contact the surface of the structure during the soldering process and form a defined soldering gap with an exemplary height of 0.3 mm.

The solder is bondable in the sleeve shaped bore holes 5 so that a respective prefabrication of the soldering base including the solder can be performed in a simple manner.

In order to prevent detrimental electromagnetic scatter fields or a field concentration at least one of the surface sides of the solder base is provided with a circumferential radius 6 of e.g. 0.2 mm.

The dimensions illustrated in FIGS. 1 and 2 are purely exemplary and to not limit the teachings of the invention.

The connection surface portion 3 can have an elbow 7 with a radius R of 0.8 mm for example.

The taper 8 is defined so that a width of the connection surface element 3 is less than a diameter of the respective circular surface segment 1; 2. In the illustrated embodiment a width of the connection surface element 3 is 4 mm, however a diameter of the circular surface segments 1; 2 is 6 mm.

1. A method for reducing a process time for soldering electrical or electronic components by electromagnetic induction heating, in particular soldering electrical contact elements with solder connection surfaces which are applied to a non-metallic substrate, in particular a glass pane, the method comprising the steps:
providing an electrical contact element configured as a solder base and made from an iron nickel or iron chromium alloy material;
applying a lead free connection material to the soldering base, wherein the connection material or the solder is made from a lead free material, in particular Bi₅₇Sn₄₂Ag₁, Bi₅₇Sn₄₀Ag₃, SnAg_{3.8}Cu_{0.7} or Sn₅₅Bi₄₄Ag₁;
positioning the soldering base on the respective solder contact surface;
inductive heating of the solder base by high frequency energy with increased heating of the solder base material and reduced heating of the material of the respective solder connection surface; and
completing the soldering step after a time period of less than or equal to 10 seconds, advantageously 4 to 6 seconds.

2. The method according to claim 1, characterized in that
the high frequency energy is in a range of 700-1500 kHz, in particular at essentially 900 kHz.

3. The method according to claim 1, characterized in that
a solder base is being used which is made from at least two non-engaging circular surfaces, circular rings, circular ring segments or circular surface segments, wherein the soldering base advantageously has protrusions forming a defined soldering gap wherein the protrusions are advantageously arranged outside of the connection surface portion.

4. An electrical connection element for contacting a conductive structure that is arranged on a flat carrier wherein the contacting is provided by a thermally bonded connection material, wherein devices for fixating a conductor are arranged on a side of the connection element that is oriented away from the conductive structure, wherein the connection element is provided as a soldering base which is approximately shaped like a figure eight, characterized in that
the soldering base is made from two non-engaging circular surfaces, circular rings, circular ring segments or circular surface segments (1; 2) which are offset from each other by a connection surface element (3).

5. The electrical connection element according to claim 4, characterized in that
the soldering base advantageously includes protrusions (4) outside of the connection surface portion (3) for forming a defined soldering gap.

6. The electrical connection element according to claim 4, characterized in that
the device for fixating the conductor is arranged in or on the connection surface element (3).

7. The electrical connection element according to claim 4, characterized in that
the thermally bonded connection material is applied on one side of the connection element and covers a surface thereon which is smaller than the circular surface or circular ring surface (1; 2).

8. The electrical connection element according to claim 7, characterized in that
the connection material is configured as a soldering tin bead which is at least partially arranged in a recess (5) or bore hole in the portion of the respective circular surface or circular ring surface (1; 2).

9. The electrical connection element according to claim 4, characterized in that
the connection element is made of an iron nickel or iron chromium alloy or from a mix thereof.
